(19) United States
(12) Patent Application Publication
(10) Pub. No.: US 2014/0278915 A1
(43) Pub. Date: Sep. 18, 2014

(54) PROVIDING PROMOTIONAL CONTENT

(71) Applicants: VERIZON PATENT AND LICENSING INC., Basking Ridge, NJ (US); CELLCO PARTNERSHIP D/B/A VERIZON WIRELESS, Basking Ridge, NJ (US)

(72) Inventors: Sagiv DRAZNIN, Walnut Creek, CA (US); Patricia R. CHANG, San Ramon, CA (US); Arda AKSU, Martinez, CA (US); Steven R. RADOS, Danville, CA (US); Thomas W. HAYNES, San Ramon, CA (US); Deepak KAKADIA, Antioch, CA (US); Priscilla LAU, Fremont, CA (US); John F. MACIAS, Antelope, CA (US); Donna L. POLEHN, Kirkland, WA (US)

(73) Assignees: CELLCO PARTNERSHIP D/B/A VERIZON WIRELESS, Basking Ridge, NJ (US); VERIZON PATENT AND LICENSING INC., Basking Ridge, NJ (US)

(21) Appl. No.: 13/843,789

(22) Filed: Mar. 15, 2013

(51) Int. Cl. G06Q 30/02

(52) U.S. Cl. CPC G06Q 30/0267
USPC 705/14.42; 705/14.64; 705/14.58; 705/14.57

(57) ABSTRACT

Systems and methods for providing promotional content are provided. Criteria defining a plurality of different activity-related modes for a user of a mobile station are stored. A message from the mobile station containing that contains information about an activity engaged in by the user is received through a mobile communication network. One of the activity-related modes for a user of a mobile station is selected upon determining that the information about the activity satisfies at least one criterion corresponding to the selected activity-related mode. Promotional content associated with the selected activity-related mode is obtained. The obtained promotional content is transmitted through the mobile communication network to the mobile station for presentation to the user.

### BACKGROUND

In recent years, an increasing number of promotional content for goods and/or services are provided to a user's mobile station. In many cases, an application running on the mobile station provides an interface for displaying the promotional content. The user may interact with the displayed promotional content to select and/or purchase goods and services at different locations as long as the user's mobile station can access the promotional content. However, the user may only be interested in selecting certain goods and/or services. Furthermore the user may be interested in different goods and/or services at different times during a day and/or at different geographical locations.

Hence a need exists for determining which goods and/or services the user would be interested in and provide the user with promotional content for goods and/or services for which the user would be interested in.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates a high-level functional block diagram of an example of a system of networks/devices that provide various communication services, including communications for providing promotional content to mobile station users.

FIG. 2 is a flow chart useful in understanding a process for providing promotional content.

FIG. 3 provides a block diagram illustration of an exemplary non-touch type mobile station 13.

FIG. 4 is a simplified functional block diagram of a computer that may be configured as a host or server, for example, to function as the notification system in the systems of FIG. 1, 2 and/or as any of the other devices illustrated in FIG. 3.

FIG. 5 is a simplified functional block diagram of a personal computer or other work station or terminal device.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The various examples disclosed herein relate to a service for providing promotional content to one or more mobile stations. A user of the service may provide a server for the service with information about the user. Examples of user information include, but are not limited to, age of the user, the user's residence information, the user's occupation, location of the user's office, etc. The information may be stored on a server that hosts the service or may be stored at another location (e.g., locally on the user's mobile station, on another server, etc.) accessible to the server hosting the service.

Activities the user engages in can be categorized into one or more activity-related modes. Activity-related modes can be user defined and/or predefined. Examples of activity-related modes include, but are not limited to, a commuting mode, which may be selected if the user is commuting in between the user's home and work, a commerce mode, which may be selected if the user is at or near commercial establishments (e.g., restaurants, retail outlets, etc.), a traveling mode, which may be selected if the user is on a trip, an emergency mode, which may be selected if the user's automobile requires attention, etc.

Each activity-related mode contains one or more required criteria, which must be satisfied for the respective activity-related mode to be selected by the server. Examples of criteria for determining which activity-related mode should be selected include, but are not limited to, the user's current geographical location, locations of interest located within a predetermined distance from the user's current geographical location, a time of day, user-designated criteria, etc. In one example, a criterion for selecting the commerce mode is satisfied if the user's mobile station is located within a predetermined distance from the nearest commercial establishment (e.g., a shopping mall, etc.). The server, upon receipt of the user's geographical location, determines if the user's mobile station is within the predetermined distance as defined by the criterion for selecting the commerce mode. The server then selects the commerce mode if the user's mobile station is determined to be within the predetermined distance from the nearest commercial establishment. In another example, a criterion for selecting the traveling mode is satisfied if the user's mobile station is located within a predetermined distance from a nearest public transportation facility. The server then selects the traveling mode if the user's mobile station is determined to be within the predetermined distance from the nearest public transportation facility. In most examples, the predetermined distance criterion is different for different activity-related modes. For example, the predetermined distance criterion for commerce may require the mobile station to be within 1 mile of the nearest commercial establishment, whereas the predetermined distance criterion for the traveling mode may require the mobile station to be within 100 yards of the nearest transportation facility.

The user may add establishments from which the user would like to receive promotional content and/or delete existing establishments from which the user does not want to receive promotional content. Promotional content for an establishment may include advertisements, marketing materials, and/or other types of materials that provide the user with information about goods and/or services offered by the establishment. Examples of promotional content for an establishment include, but are not limited to, coupons for the establishment, a listing of the goods and/or services that are provided by the establishment, information about the establishment's hours of operation, information about special promotions that are available to the user, a layout of the establishment, contact information, etc. Promotional content may include, but are not limited to, text-based content, graphical content, audio content, video content, audiovisual content, multimedia content, etc.

The user may also designate specific types of commercial establishments from which the user would like to receive promotional content. The user may also designate specific goods and/or services about which the user would like to receive promotional content. In cases where the user designates a specific type of establishment and/or specific goods and/or services about which the user would like to receive promotional content, the commerce mode is selected only if the user-designated type of establishment is located within the predetermined distance from the location of the user's mobile station and/or the user-designated goods and/or services are offered within the predetermined distance from the location of the user's mobile station. Additional criteria for selecting the commerce mode may need to be met in order for the commerce mode to be selected. In one example, an additional criterion for selection of the commerce mode limits selection of the commerce mode to certain hours during each day (e.g., non-work hours, weekends, etc.).

In another example, a criterion for selecting the traveling mode is satisfied if the user's mobile station is located within a predetermined distance from the nearest transportation facility (e.g., airport, train station, bus station, etc.). The server, upon receipt of the user's geographical location, determines if the user's mobile station is within the predetermined distance as defined by the criterion for selecting the traveling mode. The server then selects the traveling mode if the user's mobile station is determined to be within the predetermined distance from the nearest transportation facility. Additional criteria for selecting the traveling mode may need to be met in order for the traveling mode to be selected. In one example, the traveling mode is selected only on weekends, holidays, and/or days as indicated by the user.

In a further example, a criterion for selecting emergency mode is satisfied if the server receives an indication that the fuel level of an automobile the user is traveling in is below a threshold (e.g., below ⅛ of full tank, etc.). The indication may be generated by an electronic component of the user's automobile and transmitted from the electronic component to the mobile station. In that regard, a connection may be established between the user's mobile station and the electronic component to facilitate data transfer between the user's mobile station and the electronic component. In one example, a direct device-to-device connection (e.g., NFC, Bluetooth, etc.) is established between the mobile station and the electronic component to facilitate direct data transfer between the user's mobile station and the electronic component. In another example, the electronic component transmits the indication to a third electronic device (e.g., a router, an electronic component of a cell network, etc.), and the third electronic device, upon receipt of the indicator, transmits the received indicator to the user's mobile station. The mobile station, upon receipt of the indication, transmits the indication to the server. In this case, the server automatically selects the emergency mode upon receipt of the indication that the fuel level of the user's automobile is below the threshold level.

When an activity-related mode is selected either manually or automatically, promotional content associated with the selected activity-related mode are provided to user's mobile station. In one example, if the commerce mode is selected, promotional content for stores located at or near the user's geographical location are provided for display on the user's mobile station. The obtained promotional content may be based on user preference. In one example, while the server has access to a preexisting list of commercial establishments that promotional content are obtained from, the user may add additional commercial establishments and/or remove existing commercial establishments from the list of commercial establishments. In another example, the user may designate specific types of goods and/or services for which the user would like to receive promotional content. In this case, in response to the server receiving this indication (that the user would like to only receive promotional content for apparel goods) from the user device, then the server only obtains promotional content for apparel goods for the user. In another example the user may designate specific types of commercial establishments from which the user would like to receive promotional content.

If an emergency is identified and the emergency mode is selected, then promotional content for goods and/or services for the identified emergency are obtained. In one example, if an indication that the fuel level of the user's automobile is low is received, then gasoline prices of gas stations located within a predetermined distance from the user's geographical location may be automatically provided to the user's mobile station. In another example, if an indication that the user's automobile requires service is received at the server from the automobile via the user device, then promotional content for repair services within the predetermined distance from the user's geographical location is provided to the user's mobile station. Similar to the commerce mode, the obtained promotional content may be based on user preference. In one example, the user may indicate a preference for receiving automobile services of specific automobile service providers. In this case, promotional content from the designated automobile service provider are provided. Note that in the event of an emergency, as in each of the examples disclosed throughout this specification, the delivery of promotional content may be accompanied by a visual, audible, and/or tactile notification of the delivery.

The server may select multiple activity-related modes if criteria for each of the multiple activity-related modes are met. In some cases, the server may also designate one of the multiple activity-related modes to supersede the other selected activity-related modes. The server may assign a rank (e.g., based on a ranking of 1-10, 1 being the lowest and 10 being the highest rank) to each activity-related mode and select the highest ranked activity-related mode from the multiple activity-related modes. In one example, the commuting mode is assigned a rank of 10 and the commerce mode is assigned a rank of 5. In this case, if the commuting mode and the commerce mode are both selected, only promotional content associated with the commuting mode is provided.

The server may assign different rankings to an activity-related mode based on a time of the day. For example, the server may assign the commuting mode a rank of 10 between 7:00 AM-10:00 AM and a rank of 2 between 10:00 PM and 2:00 AM. The server may also assign different rankings to the activity-related mode based on a geographical location of the user's mobile station. For example, the server may assign the traveling mode a rank of 10 if the user is located within a mile of a public transportation facility (e.g., an airport, a bus station, etc.) and a rank of 5 if the user is located more than two miles from the public transportation facility. The user may also customize rankings assigned to respective activity-related mode. For example, the user may assign the commerce mode to have a higher ranking than the commuting mode. In this case, only promotional content for the commerce mode is provided to the user's mobile station. The user may elect to receive promotional content for multiple activity-related modes. For example, the user may select both the commerce mode and the traveling mode to be active. In this case, the server obtains promotional content for each of the user-selected activity-related modes and provides the obtained promotional content for display on the user's mobile station.

Reference now is made in detail to the examples illustrated in the accompanying drawings and discussed below. FIG. 1 illustrates a high-level functional block diagram of an example of a system of networks/devices that provide various communication services, including communications for providing promotional content to mobile station users. The example shows simply two mobile stations (MSs) 13a and 13b as well as a mobile communication network 15. The stations 13a and 13b are examples of mobile stations that may be used for a service for providing promotional content. However, the network will provide similar communications for many other similar users as well as for mobile stations/users that do not participate in the service for providing promotional content. The network 15 provides mobile wireless communications services to those stations as well as to other mobile stations (not shown), for example, via a number of base stations (BSs) 17. The present techniques may be implemented in any of a variety of available mobile networks 15 and/or on any type of mobile station compatible with such a network 15, and the drawing shows only a very simplified example of a few relevant elements of the network 15 for purposes of discussion here.

The wireless mobile communication network 15 might be implemented as a network conforming to the code division multiple access (CDMA) IS-95 standard, the 3rd Generation Partnership Project 2 (3GPP2) wireless IP network standard or the Evolution Data Optimized (EVDO) standard, the Global System for Mobile (GSM) communication standard, a time division multiple access (TDMA) standard or other standards used for public mobile wireless communications. The mobile stations 13 may be capable of voice telephone communications through the network 15, and for services for providing promotional content, the exemplary devices 13a and 13b are capable of data communications through the particular type of network 15 (and the users thereof typically will have subscribed to data service through the network).

The network 15 allows users of the mobile stations such as 13a and 13b (and other mobile stations not shown) to initiate and receive telephone calls to each other as well as through the public switched telephone network or “PSTN” 19 and telephone stations 21 connected to the PSTN. The network 15 typically offers a variety of data services via the Internet 23, such as downloads, web browsing, email, etc. By way of example, the drawing shows a laptop PC type user terminal 27 as well as a server 25 connected to the Internet 23; and the data services for the mobile stations 13 via the Internet 23 may be with devices like those shown at 25 and 27 as well as with a variety of other types of devices or systems capable of data communications through various interconnected networks. The mobile stations 13a and 13 of users of the service for providing promotional content also can receive and execute applications written in various programming languages, as discussed more later.

Mobile stations 13 can take the form of portable handsets, smart-phones or personal digital assistants, although they may be implemented in other form factors. Program applications, including an application to assist in the service for providing promotional content and/or any an application purchased via the on-line service for providing promotional content can be configured to execute on many different types of mobile stations 13. For example, a mobile station application can be written to execute on a binary runtime environment for mobile (BREW-based) mobile station, a Windows Mobile based mobile station, Android, I-Phone, Java Mobile, or RIM based mobile station such as a BlackBerry or the like. Some of these types of devices can employ a multi-tasking operating system.

The mobile communication network 10 can be implemented by a number of interconnected networks. Hence, the overall network 10 may include a number of radio access networks (RANs), as well as regional ground networks interconnecting a number of RANs and a wide area network (WAN) interconnecting the regional ground networks to core network elements. A regional portion of the network 10, such as that serving mobile stations 13, can include one or more RANs and a regional circuit and/or packet switched network and associated signaling network facilities.

Physical elements of a RAN operated by one of the mobile service providers or carriers, include a number of base stations represented in the example by the base stations (BSs) 17. Although not separately shown, such a base station 17 can include a base transceiver system (BTS), which can communicate via an antennae system at the site of base station and over the airlink with one or more of the mobile stations 13, when the mobile stations are within range. Each base station can include a BTS coupled to several antennae mounted on a radio tower within a coverage area often referred to as a “cell.” The BTS is the part of the radio network that sends and receives RF signals to/from the mobile stations 13 that are served by the base station 17.

The radio access networks can also include a traffic network represented generally by the cloud at 15, which carries the user communications and data for the mobile stations 13 between the base stations 17 and other elements with or through which the mobile stations communicate. The network can also include other elements that support functionality other than device-to-device media transfer services such as messaging service messages and voice communications. Specific elements of the network 15 for carrying the voice and data traffic and for controlling various aspects of the calls or sessions through the network 15 are omitted here for simplicity. It will be understood that the various network elements can communicate with each other and other aspects of the mobile communications network 10 and other networks (e.g., the public switched telephone network (PSTN) and the Internet) either directly or indirectly.

The carrier will also operate a number of systems that provide ancillary functions in support of the communications services and/or application services provided through the network 10, and those elements communicate with other nodes or elements of the network 10 via one or more private IP type packet data networks 29 (sometimes referred to as an Intranet), i.e., a private networks. Generally, such systems are part of or connected for communication via the private network 29. It should be apparent, however, one would recognize that systems outside of the private network could serve the same functions as well. Examples of such systems, in this case operated by the network service provider as part of the overall network 10, which communicate through the intranet type network 29, include one or more application servers 31 and a related authentication server 33 for the application service of server 31.

A mobile station 13 communicates over the air with a base station 17 and through the traffic network 15 for various voice and data communications, e.g., through the Internet 23 with a server 25. If the mobile service carrier offers the service for providing promotional content, the service may be hosted on a carrier operated application server 35, for communication via the networks 15 and 29. In the example, the network operator operates the servers, such as 35 to provide and support the service for providing promotional content. Alternatively, the service for providing promotional content may be provided by a separate entity (alone or through agreements with the carrier), in which case, the service may be hosted on an application server such as server 25 connected for communication via the networks 15 and 23. Servers, such as 25 and 35 may provide any of a variety of common application or service functions in support of or in addition to an application program running on the mobile station 13. However, for purposes of further discussion, we will focus on functions thereof in support of the service for providing promotional content. For a given service, including the service for providing promotional content, an application program within the mobile station may be considered as a ‘client’ and the programming at 25 or 35 may be considered as the ‘server’ application for the particular service.

Position Determining Entity (PDE) 31 manages the position or geographic location determination of each mobile station, including providing the acquisition assistance data to the mobile station. The PDE 31 is essentially a general purpose programmable device with an interface for data communication via the network 15. The PDE 31 stores or has access to a complete and up to date set of the satellite data needed for computing locations of the mobile stations based on GPS signals. The stored satellite data allow locations of the mobile stations to be identified.

Location Proxy Server (LPS)/Location Based Service (LBS) server 33 provides various location based services to the mobile stations. At a high level, the LPS/LBS server 33 receives and identifies location information of the mobile stations from the PDE 31 and provides various location based services to each of the mobile stations appropriate for the location of each of the mobile stations. The various location based services include a service for providing promotional content to a mobile station that delivers an electronic promotional offer relevant to location of the mobile station, which will be explained below.

When a mobile station 13 attempts a GPS position fix, the mobile station 13 provides information allowing the PDE 31 to perform a pre-fix. Typically, the mobile station 13 will provide data identifying the base station 17 through which it is receiving service (and possibly the serving sector). In some implementations, the PDE 31 may receive data regarding several base stations/sectors and signal strengths thereof, for trilateration. The PDE 31 uses information about base station location(s) to process the data received from the mobile station so as to determine a region (e.g., area of the cell or sector, or a general area triangulated based on signals from several base stations) that the mobile station 13 is likely located within. The PDE 31 then uses the pre-fix location to parse satellite data down to assistance data that the mobile station 13 at the particular location needs in order to take GPS readings. The PDE 31 sends the parsed satellite data to the mobile station 13, for use in taking measurements of signals from appropriate satellites. The GPS assistance data may contain selected satellite almanac, satellite visibility, Doppler and clock correction information.

The mobile station 13 will, in turn, use this information (also known as acquisition assistance records) to take multiple satellite pseudorange measurements. Depending on the device/network configuration, the mobile station 13 or the PDE 31 can then calculate a final fix using these pseudorange measurements. The final fix computation provides latitude and longitude (and possibly altitude) coordinates for the current location of the mobile station 13. If the mobile station 13 has full GPS computation capability, the station 13 can calculate the current latitude and longitude of the mobile station itself. With either approach, the current latitude and longitude of the mobile station can be provided to and processed by a location based service application within the device and/or running on a server in communication with the device via the network 15.

The LPS/LBS 33 may support location requests from LBS software application(s). As an overview of a process by which a third party application is provided with the location of a mobile station 13, a request for location from a LBS application is translate into a mobile location protocol (MLP) command and provided to the LPS/LBS 33. The LPS/LBS 33 works through the user plane positioning environment, including the PDE and the location determination functionality of the mobile station, to extract device position. The LPS functions respond to the LBS applications with the location of the mobile station 13.

For many location-based applications today, further processing or access is needed. To provide access to general users, e.g., mobile subscribers and authorized third party users, the carrier also operates a location proxy server (LPS). For simplicity, the drawing showing the LPS running on the same server platform 33 as the carrier's location based service application, although in an actual deployment, these applications may run together or separately on any number of hardware platforms. In the example, the LPS executes a queue manager for managing communications and access to the various LPS program modules. The LPS program modules include a thin API proxy client, for client-server proxy communications with the mobile stations, such as the target mobile station 13. The LPS program modules also include a PDE adapter, for communications through the network with the PDE 31, e.g., for situations in which the LPS 33 needs to obtain mobile station position data from the PDE 31.

For purposes of the present discussion, the LPS program modules also include a user privacy component (UPc) and a Geographic Information System (GIS) component module. The UPc module uses the MS-MPC protocol to communicate through the network 15 with the mobile stations 13. The UPc module manages and enforces subscriber permissions with regard to access to a user's location data, and this module authenticates all applications before allowing location fixes with regard to a mobile station location. For example, during a location operation regarding the mobile station 13, this module authenticates the device software for access to the location information regarding that mobile station 13.

The GIS component module provides location specific information, such as mapping data (maps, roads, points of interest, etc.) and associated coding functions. As discussed more later, this GIS component module provides a Maps API utilized in the promotional offer delivery, for example, as may be used to determine locations associated with promotional offers that are within a particular distance range of the current location of a user's mobile station 13.

In general, a party or system (e.g., the altering engine and/or the LBS server application involved in the offer delivery) that needs or desires location information with regard to a mobile station 13 contacts the LPS/LBS 33. The LPS 33 authenticates that party and application and provides location related information. When location of a mobile station 13 is needed for an offer delivery, the LPS/LBS 33 then directs the mobile station to the PDE 31 for a position fix of the type outlined above in the discussion of the GPS example.

Notification system 35 receives information about users of mobile stations via an interactive interface through which the users input the user's preference in response to inquiries. Examples of information about a mobile station user include, but are not limited to, the user's age, residence information, occupation, schedule, preferred establishments, etc. This information may be stored in server 25 or another server associated with a carrier serving the mobile station. Examples of preferred establishments include, but are not limited to restaurants, department stores, clothing stores, sporting goods stores, etc., and the user's location preference may set a distance range of a location of a preferred establishment from the mobile station user's location.

In our examples, the notification system server 35 also can receive messages with preferences requesting electronic offers, when the request messages are sent by the mobile stations of the users. The interactive interface may be a webpage accessible via the Internet or an application running on mobile stations. The mobile station users input various requests about electronic promotional offer delivery such as categories or names of points of sales in which the user is interested, and preferable delivery period of promotional content via the interface, by their own or in response to queries by the notification system 35. Alternatively, mobile station users may send a mobile messaging service message including their preferences regarding promotional content to the notification system 35.

The notification system 35 receives electronic promotional content from various promotional content providers 36. In the carrier provider service example, the offer providers would operate their own server(s) 36. The notification system 35 categorizes and stores received promotional content according to location of promotional content providers 36 and types of electronic promotional offers. The notification system 35 determines locations of mobile stations based on location information provided from LPS/LBS 33 and finds electronic promotional offers appropriate for the locations of the mobile stations and sends the found electronic promotional offers to the mobile stations. The electronic promotional offers may be a Short Message Service (SMS) message or a Multimedia Message Service (MMS) message sent via a SMSC or a MMSC. The offer delivery can be triggered by time in relation to a user's preferred delivery schedule or by a specific request message from the user. The request and/or offer delivery uses standard mobile messaging services communications, for example, SMS, MMS or EMS.

FIG. 2 is a flow chart useful in understanding a process for providing promotional content. Although the operations in process 200 are shown in a particular order, certain operations may be performed in different orders or at the same time. In addition, although process 200 is described with reference to the mobile station 13 of FIG. 1, process 200 is not limited to such and can be performed by other mobile stations.

Notification system 35 receives messages that include criteria defining different activity-related modes. Examples of activity-related modes include, but are not limited to, a commerce mode, a commuting mode, a traveling mode, an emergency mode, etc. In one example, the commerce mode is selected if notification system 35 determines that the user is commuting to and/or from work. If the commuting mode is selected, the user is provided with promotional content the user may be interested in while the user is commuting to and from work. In one example, the traveling mode is selected if notification system 35 determines that the user is on a trip. One criterion for selecting the traveling mode could be based on a distance from the location of the user's mobile station and the user's home. Another criterion for selecting the traveling mode could be based on a distance from the location of the user's mobile station to a public transportation facility. If the traveling mode is selected, the user is provided with promotional content for goods and/or services the user may be interested in while the user is traveling. In one example, the commerce mode is selected if notification system 35 determines that the user is at or near a commercial establishment. If the commerce mode is selected, the user is provided with promotional content offered by the commercial establishment. In one example, the emergency mode is selected if notification system 35 receives an indication that the user's automobile requires immediate attention (e.g., the fuel level of the user's automobile is low, etc.).

An activity-related mode may be predefined by notification system 35, created by the user, and/or created by another user that receives promotional content from notification system. In one example, the user designates criteria defining different activity-related modes and the designated criteria are transmitted from mobile station 13 to notification system 35.

As shown in FIG. 2, notification system 35 stores criteria corresponding to different activity-related modes for a mobile station of the user in block S205. The criteria may be stored in a storage location of the notification system 35 and/or another storage location that is accessible to notification system 35. The user may personalize criteria defining the activity-related mode. In one example, notification system 35 may define that a criterion for the commerce mode would be met if mobile station is located within a predetermined distance from a commercial enterprise (e.g., an outlet, a grocery store, etc.). In this case, the user may modify the preselected distance, within which the criterion defining the commerce mode would be triggered. The user may also designate additional criteria defining the commerce mode (e.g., a range of time during a particular day, during which the commerce mode would be triggered, specific days during a week, during which the commerce mode would be triggered, etc.). The user may also designate additional establishments as commercial enterprises and/or remove currently listed commercial enterprises.

The user may share a preselected and/or user created activity-related mode with other users of the service for providing promotional content. The user may provide an activity-related mode to other users within the user's social network. The user may specify a subgroup of other users with whom, the user would like to share the preselected and/or user created activity-related mode. For example, the user may elect to share the user's commute mode with the user's coworkers who are within the user's social network. In that regard, notification system 35, upon receipt of a user request to share the user's commute mode with coworkers who are within the user's social network, identifies the coworkers, and provides each of the coworkers with the user's commuting mode.

For each activity-related mode, the user may designate, via mobile station 13, criteria for initiating the respective activity-related mode. In one example, the user may provide notification system 35 with the user's residential address and the user's work address. Notification system 35, upon receipt of the respective addresses, determines routes that the user may take to and from work. In this case, the commuting mode would be initiated if the user is determined to be traveling along one of the determined routes. In another example, the criteria for initiating the traveling mode would be met if the user is within a predetermined distance from a public transportation facility (e.g., an airport, a train station, etc.). In a further example, the criteria for initiating the traveling mode would be met if the user's location is outside of a predetermined distance from (e.g., greater than 50 miles, etc.) the user's residential address. A value corresponding to the predetermined distance may be preselected (e.g., determined by the notification system) or user-designated.

The user's mobile station may receive performance indications (e.g., fuel level, engine oil level, whether service light is on, etc.) for an automobile that the user is operating. The performance indications may be obtained from one or more electronic sensors in the user's automobile and transmitted to the user's mobile station. The user may designate criteria for initiating the emergency mode to be met based on the received performance indications. For example, the user may designate that a criterion for the emergency mode is met if the fuel level is below a threshold value. In another example, the user may also designate that a criterion for the emergency mode is met if the mobile station receives an indication from an electronic component (e.g., a processor of the user's car) that an issue has arisen. For example, a processor of the user's automobile may determine that the automobile's engine light is on. The processor then executes instructions to transmit (e.g., directly through a NFC connection, a Bluetooth connection, indirectly through a cell network, etc.) an indication that an issue has arisen to the mobile station. The mobile station, upon receiving the indication, requests the notification system 35 to select the emergency mode.

Different activity-related modes may be assigned to have different priority levels. In one example, a default priority level may be assigned to each respective activity-related mode. Furthermore, the user may modify the default priority level of each respective activity-related mode. In one example, the notification system 35 may designate the commuting mode to have a priority level of 1, the traveling mode to have a priority level of 5, and commerce mode to have a priority level of 8 from a scale of 1-10, where 1 is the lowest priority level and 10 is the highest priority level. The user may subsequently modify the priority level for any of the activity-related modes.

In block S210, notification system 35 receives a message that contains information about an activity engaged in by the user of mobile station 13 through a mobile communication network (e.g., network 29). In one example, the received information identifies user activities involving mobile station 13 and is transmitted directly from mobile station 13 via the mobile communication. The received information may also identify a specific timestamp corresponding to an approximate time, at which the information was transmitted from mobile station 13 to notification system 35. In another example, the received information is transmitted from LPS/LBS server 33 and contains a geographical location of mobile station 13.

The notification system 35 determines if the received information satisfies at least one criterion for any of the activity-related modes. In one example, notification system 35 receives a location of the user's mobile station, and based on the received location, determines whether the user is within a preselected predetermined distance from a commercial enterprise. In another example, notification system 35 receives several locations of the user's mobile station, and based on the received locations, determines whether the user is on a route to or from work. In another example, notification system 35 determines, based on a received location of the user's mobile station, whether the user is within a predetermined distance from a public transportation facility and/or outside of a predetermined distance from the user's home. In a further example, notification system 35, receives several performance indicators about the user's automobile, and determines, based on the received performance indicators, whether the emergency mode should be initiated.

Each of the activity-related modes may include additional criteria, which must be met in order for the respective activity-related mode to be selected by notification system 35. One criterion for the commuting mode, the traveling mode, and the commerce mode may be based on a time of the day the information was received. Another criterion for the commuting mode, the traveling mode, and the commerce mode may be based on whether the day is a weekday, a weekend, or a holiday. The user may modify criteria for the activity-related modes. For example, the user may add additional criteria for one of the activity-related modes and delete a predetermined criterion the same activity-related mode.

In block S215, notification system 35 selects one of the activity-related modes for the user upon determining that the information about the activity satisfies at least one criterion corresponding to the selected activity-related mode. Some activity-related modes contain multiple criteria. In this case, notification system 35 would select the activity-related mode only if all criteria for the activity-related mode are satisfied. For example, if the commuting mode includes a first criterion that requires the location of the user's mobile station to be in between the user's home and work and a second criterion that requires the user to be traveling on a weekday, then notification system 35 would only select the traveling mode if the user is traveling from home to work on a weekday. Alternatively, notification system would select the activity-related mode if some of the criteria for the activity-related mode are satisfied.

The received information may satisfy criteria for two or more of the activity-related modes. In this case, one of the two or more activity-related modes that has a highest priority level may be selected. In another example, if the received information satisfies criteria for multiple activity-related modes, each of the multiple activity-related modes is selected. For example, if criteria for both the commerce mode and the traveling mode are satisfied, then both activity-related modes are selected.

The user may be provided an option to manually select which activity-related mode the user would like to be selected. In one example, the user may manually select the traveling mode. In this case, the traveling mode remains selected until the user unselects the traveling mode and/or selects another activity-related mode. The user may designate certain activity-related modes for certain times during a day. For example, the user may designate the commuting mode to be active around morning commute times and for the commerce mode to be active during weekends.

In block S220, notification system 35 obtains promotional content associated with the selected activity-related mode. The promotional content may be obtained from promotional content providers 36 and/or other accessible servers that contain promotional content. Promotional content may include, but are not limited to, audio-based content, video-based content, audiovisual based content, text-based content, graphical content, etc. In one example, if the commerce mode is selected, and a current location of the user's mobile station and a timestamp corresponding to a time mobile station 13's location is transmitted are both received, then eligible promotional content for goods and/or services that can be purchased at establishments that are open within a temporal period of the current time and are located within a predetermined distance from the determined location of mobile station are obtained. The obtained promotional content may also include information about establishments (e.g., business hours, location, customer rating, promotions, contact information, etc.) that provide the goods and/or services. The user may indicate types of commercial establishments from which the user would like to receive promotional content. In that regard, only promotional content from user-indicated types of establishments would be obtained. The user may also indicate specific goods and/or services for which the user would like to receive promotional content. In that regard, only promotional content for the user indicated goods and/or services would be obtained.

In another example, if the traveling mode is selected, then notification system 35 may obtain promotional content associated with places of interest that are located within a predetermined distance from the location of the user's mobile station. The user may indicate types of places of interest that the user would like to visit. In that regard, only promotional content for the user-indicated places of interest would be obtained. In a further example, if the commuting mode is selected, then notification system 35 may obtain promotional content associated with goods and/or services (e.g., coffee, groceries, etc.) that the user may elect to purchase while the user is on the way to and/or from work.

The user may indicate types of goods and/or services for which would like to obtain while the user is in the commuting mode. In that regard, only promotional content for the user-indicated goods and/or services would be obtained. In a further example, if the emergency mode is selected, then based on a type of the emergency (e.g., whether the fuel level for the user's automobile is low, service for the user's automobile is required, etc.) notification system 35 may obtain promotional content for goods and/or services (e.g., gasoline, service shop, etc.) at or near the user's determined geographical location.

In Block S225, notification system 35 transmits the obtained promotional content through the mobile communication network to the mobile station for presentation to the user. Notification system 35 may also rank the obtained promotional content and transmit promotional content having a value exceeding a threshold value to the mobile station for presentation of the user. For example, the obtained promotional content is given a score between 1 and 100 and is transmitted to the user only if the promotional content has a score of 50 or higher, a threshold that may be explained to, and set by, the user.

In one example, if the obtained promotional content has previously been transmitted to the user, then the obtained promotional content is ranked based on prior user interaction with the obtained promotional content. In that regard, if the user had previously selected the obtained promotional content, then the obtained promotional content would be assigned a higher score than if the user had ignored the obtained promotional content. For example, if the user previously selected a promotional content for a good and purchased the good after selecting the promotional content, the purchase is identified as an indication of the user's interest in the good and promotional content for the good is associated with a higher ranking as a result of the purchase. The promotional content may also be ranked based on the cost of the purchased good and/or service. For example, the numerical value of the promotional content's rank is directly proportional to the cost of the goods and/or services that associated with the promotional content. The promotional content may also be ranked based on a number of times the user has purchased goods and/or services associated with the promotional content. For example, the numerical value of the promotional content's rank is directly proportional to the number of times the user has purchased goods and/or services associated with the promotional content.

Notification system 35 may also rank the obtained promotional content based on prior user interactions by other users that have previously received the obtained promotional content from notification system 35. In one example, the ranking is based on a number of selections by the other users compared to a number of other users that previously received the obtained promotional content. The ranking may be an aggregate ranking based every user of the service for providing promotional content. The ranking may also be weighted based on geographical region, relationship of other users to the user, etc. Information about the other users' may be stored on a data store of notification system 35. In one example, the rankings may be based on selections by other users who are located within 100 miles of the location of the user's mobile station. In another example, the rankings may be limited to selections by other users who are within the user's social network or within a subgroup of the user's social network.

The rankings may also be based on other characteristics and/or demographics of the other users of the service. Examples of other characteristics, include, but are not limited to age, sex, income, education, marital status, etc. Additional factors include a time during the day the promotional content is selected, etc. For example, promotional content for a night club may be assigned different rankings based on a time during the day the promotional content for the night club was obtained. In that regard, the promotional content for the night club would be ranked higher at a time when many patrons are expected to be at the night club (e.g., in the evening to early morning time frame) than at a time when fewer patrons are expected to be at the night club (e.g., in the late afternoon around opening time).

Notification system 35 may receive a user selection of a transmitted promotional content. Notification system 35 may also receive a user indication to purchase an item associated with the promotional content. Notification system 35, upon receipt of the user indication to purchase the item associated with the promotional content may facilitate an electronic transaction to purchase the item. In one example, notification system 35, upon receipt of the user indication to purchase the item associated with the promotional content, transmits information about the item (e.g., cost of the item, number of items purchased, date of the purchase, etc.) to an electronic billing system that maintains a user billing account (e.g., a billing account for the user's mobile station service). The billing system processes the information and includes a charge for the cost of the item to the user's balance. The billing system may generate a periodic bill that reflects the user's unpaid balance and provide the generated bill to the user via the mobile station. In another example, notification system 35 provides a secure interface to the mobile station that allows the user to enter user credentials (e.g., credit card information, etc.) for purchasing the item (e.g., credit card information). Notification system 35 then provides the user credentials to a server that hosts a service for processing electronic payments (e.g., a server that hosts a credit card service). If notification system 35 has been configured to accept a form of preconfigured payment method (e.g., preconfigured credit card service), the user may elect to pay for the item with the preconfigured payment method. In another example, if the user is subscribed to an electronic wallet service, notification system 35 may process the payment of the item via the electronic wallet service.

The enhanced service for providing promotional content under consideration here may be delivered to touch screen type mobile stations as well as to non-touch type mobile stations. Implementation of the service for providing promotional content will involve at least some execution of programming in the mobile stations as well as implementation of user input/output functions and data communications through the network 15, between the mobile stations and one or more servers.

Those skilled in the art presumably are familiar with the structure, programming and operations of the various types of mobile stations. However, for completeness, it may be useful to consider the functional elements/aspects of two exemplary mobile stations 13a and 13b, at a high-level, as will be discussed later with regard to FIG. 3.

FIG. 3 provides a block diagram illustration of an exemplary non-touch type mobile station 13. Although the mobile station 13 may be a smart-phone or may be incorporated into another device, such as a personal digital assistant (PDA) or the like, for discussion purposes, the illustration shows the mobile station 13 is in the form of a handset. The handset embodiment of the mobile station 13 functions as a normal digital wireless telephone station. For that function, the station 13 includes a microphone 102 for audio signal input and a speaker 104 for audio signal output. The microphone 102 and speaker 104 connect to voice coding and decoding circuitry (vocoder) 106. For a voice telephone call, for example, the vocoder 106 provides two-way conversion between analog audio signals representing speech or other audio and digital samples at a compressed bit rate compatible with the digital protocol of wireless telephone network communications or voice over packet (Internet Protocol) communications.

For digital wireless communications, the mobile station 13 also includes at least one digital transceiver (XCVR) 108. Today, the mobile station 13 would be configured for digital wireless communications using one or more of the common network technology types. The concepts discussed here encompass embodiments of the mobile station 13 utilizing any digital transceivers that conform to current or future developed digital wireless communication standards. The mobile station 13 may also be capable of analog operation via a legacy network technology.

The transceiver 108 provides two-way wireless communication of information, such as vocoded speech samples and/or digital information, in accordance with the technology of the network 15. The transceiver 108 also sends and receives a variety of signaling messages in support of the various voice and data services provided via the mobile station 13 and the network 15. Each transceiver 108 connects through RF send and receive amplifiers (not separately shown) to an antenna 110. The transceiver 108 may also support various types of mobile messaging services, such as short message service (SMS), enhanced messaging service (EMS) and/or multimedia messaging service (MMS).

A GPS receiver 124 may share the same antenna 110 used by the transceiver 108, or there may be a separate additional antenna for the GPS receiver 124. Under control of the microprocessor 122, the GPS receiver 124 receives and processes signals from one or more satellites of the constellation of GPS satellites. From its processing, the GPS receiver 121 supplies GPS data to the microprocessor 122, such as pseudorange measurements and associated PN codes for measured satellite signals. Associated computations may be performed in the microprocessor 122 or by a processor or the like included in the GPS receiver 124.

The mobile station 13 includes a display 118 for displaying messages, menus or the like, call related information dialed by the user, calling party numbers, etc., including the service for providing promotional content. A keypad 120 enables dialing digits for voice and/or data calls as well as generating selection inputs, for example, as may be keyed-in by the user based on a displayed menu or as a cursor control and selection of a highlighted item on a displayed screen. The display 118 and keypad 120 are the physical elements providing a textual or graphical user interface. Various combinations of the keypad 120, display 118, microphone 102 and speaker 104 may be used as the physical input output elements of the graphical user interface (GUI), for multimedia (e.g., audio and/or video) communications. Of course other user interface elements may be used, such as a trackball, as in some types of PDAs or smart phones.

In addition to normal telephone and data communication related input/output (including message input and message display functions), the user interface elements also may be used for display of menus and other information to the user and user input of selections, including any needed during user's subscription processes and the electronic promotional offer delivery processes.

A microprocessor 122 serves as a programmable controller for the mobile station 13, in that it controls all operations of the mobile station 13 in accord with programming that it executes, for all normal operations, and for operations involved in the electronic promotional offer delivery procedure under consideration here. In the example, the mobile station 13 includes flash type program memory 114, for storage of various “software” or “firmware” program routines and mobile configuration settings, such as mobile directory number (MDN) and/or mobile identification number (MIN), etc. The mobile station 13 may also include a non-volatile random access memory (RAM) 116 for a working data processing memory. Of course, other storage devices or configurations may be added to or substituted for those in the example. In a present implementation, the flash type program memory 114 stores firmware such as a boot routine, device driver software, an operating system, call processing software and vocoder control software, and any of a wide variety of other applications, such as client browser software and short message service software. The memories 114, 116 also store various data, such as telephone numbers and server addresses, downloaded data such as multimedia content, and various data input by the user. Programming stored in the flash type program memory 114, sometimes referred to as “firmware,” is loaded into and executed by the microprocessor 122.

As outlined above, the mobile station 13 includes a processor, and programming stored in the flash memory 114 configures the processor so that the mobile station is capable of performing various desired functions, including in this case the functions involved in the technique for providing the service for providing promotional content including LBS applications 126, which includes programming that supports the service for providing promotional content. Other aspects of the service for providing promotional content are implemented in platforms connected to the networks, such as the notification system 35 and/or the LPS/LBS 33. These elements could be special purpose devices. However, in the example, these elements are implemented by appropriate configuration and/or programming of general purpose computers.

As known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data, e.g., files used for the service for providing promotional content. The software code is executable by the general-purpose computer that functions as the notification system server 35, the PDE 31 and LPS/LBS 33. In operation, the code is stored within the general-purpose computer platform. At other times, however, the software may be stored at other locations and/or transported for loading into the appropriate general-purpose computer system. Execution of such code by a processor of the computer platform enables the platform to implement the methodology for providing the service promotional content, in essentially the manner performed in the implementations discussed and illustrated herein.

FIGS. 4 and 5 provide functional block diagram illustrations of general purpose computer hardware platforms. FIG. 4 illustrates a network or host computer platform, as may typically be used to implement a server. FIG. 5 depicts a computer with user interface elements, as may be used to implement a personal computer or other type of work station or terminal device, although the computer of FIG. 5 may also act as a server if appropriately programmed. It is believed that the general structure and general operation of such equipment as shown in FIGS. 4 and 5 should be self-explanatory from the high-level illustrations.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature. Of course, the server functions may be implemented in a distributed fashion on a number of similar platforms, to distribute the processing load.

A computer type user terminal device, such as a PC or tablet computer, similarly includes a data communication interface CPU, main memory and one or more mass storage devices for storing user data and the various executable programs (see FIG. 6). A mobile station type user terminal may include similar elements, but will typically use smaller components that also require less power, to facilitate implementation in a portable form factor. The various types of user terminal devices will also include various user input and output elements. A computer, for example, may include a keyboard and a cursor control/selection device such as a mouse, trackball, joystick or touchpad; and a display for visual outputs. A microphone and speaker enable audio input and output. Some smartphones include similar but smaller input and output elements. Tablets and other types of smartphones utilize touch sensitive display screens, instead of separate keyboard and cursor control elements. The hardware elements, operating systems and programming languages of such user terminal devices also are conventional in nature.

Hence, aspects of the methods for providing promotional content outlined above may be embodied in programming. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the service for providing promotional content into the computer platform of the notification system or LBS/LPS. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the service for providing promotional content, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising steps of:
storing criteria defining a plurality of different activity-related modes for a user of a mobile station;
receiving a message, from the mobile station through a mobile communication network, containing information about an activity engaged in by the user of the mobile station;
selecting one of the activity-related modes for a user of a mobile station, upon determining that the information about the activity satisfies at least one criterion corresponding to the selected activity-related mode;
obtaining promotional content associated with the selected activity-related mode; and
transmitting the obtained promotional content through the mobile communication network to the mobile station, for presentation to the user.

2. The method of claim 1, wherein:
the information comprises a geographical location of the mobile station,
the one of the activity-related modes is selected based on the geographical location of the mobile station, and
promotional content for enterprises that are located within a predetermined distance from the geographical location of the mobile station and associated with the selected activity-related mode are obtained and transmitted through the mobile communication network to the mobile station.

3. The method of claim 1, wherein:
one of the activity-related modes is a commerce mode, and
one of the at least one criterion corresponding to the commerce mode is satisfied if the mobile station is within a predetermined distance from a commercial enterprise.

4. The method of claim 1, wherein:
one of the activity-related modes is a commuting mode, and
one of the at least one criterion corresponding to the mode for commuting is satisfied if, based on the information, the user is determined to be on a route to work.

5. The method of claim 1, wherein:
one of the activity-related modes is a mode for traveling, and
one of the at least one criterion corresponding to the mode for traveling is satisfied if, based on the information, the user is determined to be outside a predetermined distance from a location of a place of residence of the user.

6. The method of claim 1, wherein the criteria are stored in response to selections received from the user.

7. The method of claim 1, wherein:
the different activity-related modes have two or more different assigned priority levels, and
upon the information about the activity satisfying one or more criterion corresponding to two of the activity-related modes, the step of selecting one of the activity-related modes for a user of a mobile station comprises selecting one of the two activity-related modes having higher priority level assigned thereto.

8. The method of claim 1, further comprising receiving a user selection of one of the activity-related modes, wherein the obtained promotional content is associated with the user-selected activity-related mode.

9. The method of claim 1, further comprising:
ranking the obtained promotional content associated with the selected activity-related mode, wherein transmitting the obtained promotional content includes transmitting only the obtained promotional content having a ranking exceeding a threshold through the mobile communication network to the mobile station, for presentation to the user.

10. The method of claim 9, further comprising:
determining whether the obtained promotional content has previously been transmitted to the mobile station; and
upon determining the obtained promotional content has previously been transmitted to the mobile station, identifying prior user selection of the obtained promotional content; and
performing the ranking based on the prior user selection of the obtained promotional content.

11. The method of claim 9, further comprising:
receiving a user selection of transmitted promotional content; and
facilitating an electronic transaction to purchase an item associated with the promotional content.

12. The method of claim 9, wherein:
the user is a member of a service that provides promotional content to the user's mobile station, and
the ranking is based on a number of selections by other users of the service.

13. A system for providing promotional content, the system comprising:
one or more processors; and
a machine-readable medium comprising instructions stored therein, which when executed by the processors, cause the processors to perform operations comprising:
storing criteria defining a plurality of different activity-related modes for a user of a mobile station;
receiving a message from the mobile station through a mobile communication network, containing information about an activity engaged in by the user of the mobile station, wherein the information comprises a geographical location of the mobile station;
selecting one of the activity-related modes for a user of a mobile station, upon determining that the information about the activity satisfies at least one criterion corresponding to the selected activity-related mode;
obtaining promotional content associated with the selected activity-related mode, wherein promotional content for enterprises that are located within a predetermined distance from the geographical location of the mobile station are obtained and transmitted through the mobile communication network to the mobile station; and
transmitting the obtained promotional content through the mobile communication network to the mobile station, for presentation to the user.

14. The system of claim 13, wherein:
the different activity-related modes have two or more different assigned priority level; and
upon the information about the activity satisfying one or more criterion corresponding to two of the activity-related modes, the step of selecting one of the activity-related modes for a user of a mobile station comprises selecting one of the two activity-related modes having higher priority level assigned thereto.

15. The system of claim 13, wherein:
one of the activity-related modes is a commerce mode, and
one of the at least one criterion corresponding to the commerce mode is satisfied if the mobile station is within a predetermined distance from a commercial enterprise.

16. The system of claim 13, wherein:
one of the activity-related modes is a mode for commuting, and
one of the at least one criterion corresponding to the mode for commuting is satisfied if, based on the information, the user is determined to be on a route to work.

17. The system of claim 13, wherein:
one of the activity-related modes is a mode for traveling, and
one of the at least one criterion corresponding to the mode for traveling is satisfied if, based on the information, the user is determined to be outside a predetermined distance from a location of a place of residence of the user.

18. The system of claim 13, further comprising:
ranking the obtained promotional content associated with the selected activity-related mode, wherein transmitting the obtained promotional content includes transmitting only the obtained promotional content having a ranking exceeding a threshold through the mobile communication network to the mobile station, for presentation to the user.

19. The system of claim 13, further comprising:
determining whether the obtained promotional content has previously been transmitted to the mobile station; and
upon determining the obtained promotional content has previously been transmitted to the mobile station, identifying prior user selection of the obtained promotional content; and
and performing the ranking based on the prior user selection of the obtained promotional content.

20. A machine-readable medium comprising instructions stored therein, which when executed by a system, cause the system to perform operations comprising:
storing criteria defining a plurality of different activity-related modes for a user of a mobile station;
receiving a message from the mobile station through a mobile communication network, containing information about an activity engaged in by the user of the mobile station;
selecting one of the activity-related modes for a user of a mobile station, upon determining that the information about the activity satisfies at least one criterion corresponding to the selected activity-related mode;
obtaining promotional content associated with the selected activity-related mode;
ranking the obtained promotional content associated with the selected activity-related mode; and
transmitting only the obtained promotional content associated with the selected activity-related mode and having a ranking exceeding a threshold are obtained and transmitted through the mobile communication network to the mobile station, for presentation to the user.
